(19) United States
(12) Patent Application Publication
(10) Pub. No.: US 2010/0031276 A1
(43) Pub. Date: Feb. 4, 2010

(54) Method for Constructing Virtual Operating System

(75) Inventor: Wei-Ling Hsieh, Beijing (CN)

Correspondence Address: COATS & BENNETT, PLLC, 1400 Crescent Green, Suite 300, Cary, NC, 27518, US

(73) Assignee: EUNOVATION INT'L LIMITED, Hong Kong (CN)

(21) Appl. No.: 12/270,434

(22) Filed: Nov. 13, 2008

(30) Foreign Application Priority Data
Aug. 4, 2008 (CN) 200810117734.2

(51) Int. Cl. G06F 3/00; G06F 9/44; G06F 9/46; G06F 13/00

(52) U.S. Cl. 719/331

(57) ABSTRACT

The present invention provides a method for constructing a virtual operating system (VOS), the method comprises according to executable code of an application program loaded in user-mode memory space, acquiring library invoking information of an operating system (OS) library to be invoked for executing the application program; according to the library invoking information, modifying an access path of the OS library to be invoked by the application program so as to make the application program invoke the VOS instead; and a VOS loader loading program code corresponding to the VOS into user-mode memory space. When a computer run in user mode, the VOS serves as a general library, and application programs will not invoke the OS interface directly, but invoke the VOS instead, which does not need to run in kernel mode and has a wide range of applications, high stability, and security. Furthermore, the present invention is flexible to construct different VOSs for applications in different virtual environments according to requirements.

### CROSS-REFERENCE TO RELATED APPLICATIONS

This application claims priority to Chinese Patent Application No. 200810117734.2, filed on Aug. 4, 2008, entitled “Method for Constructing Virtual Operating System”, which is incorporated herein by reference in its entirety.

### FIELD OF THE TECHNOLOGY

The present invention relates to a field of computer technology, particularly to a method for constructing a virtual operating system.

### BACKGROUND OF THE INVENTION

With the continuous development of computer technology, the function of computers is increasingly powerful, which has been covering every aspect of people's lives including study, entertainment, office working, and shopping. Although the mobile storage devices or storage servers bring convenience to users and enable the users to work on different computers, different computer working environments and installed application software are widely divergent, which brings great distress to the users. A virtual operation system (VOS) can solve such problems. A VOS is a special program running on the host operating system. The VOS is adapted to simulate the operating system (OS) of a host PC.

An OS generally is divided into at least user mode and kernel mode. The way of constructing a VOS in the prior art is to write the VOS program into kernel-mode memory space, that is, write the VOS program into the real OS. The modification to the kernel of OS requires the system administrator privilege and must be done in the kernel mode. But most of the existing computers are running in the user mode and not opening up the kernel mode, so the method for constructing VOS in the prior art can not run on most computers, which has poor application flexibility. In addition, in prior art, the VOS program is written into the OS. Because the modification of the OS may result in system instability, all the applications running on the modified OS may be damaged. Once the modified code has defects, the whole system may crash and important data may be lost, which leads to poor stability and security.

### SUMMARY OF THE INVENTION

The invention provides a method for constructing a VOS to resolve the defects existing in the prior art that the construction of the VOS in the kernel mode has poor flexibility, stability, and safety, and to increase the flexibility and stability of constructing a VOS.

In order to implement the above subject, the present invention provides a method for constructing a VOS. The method comprises the following steps:

according to executable code of an application program loaded in user-mode memory space, acquiring library invoking information of an OS library to be invoked for executing the application program;

according to the library invoking information, modifying an access path of the OS library to be invoked by the application program so as to make the application program invoke the VOS instead; and

a VOS loader loading program code corresponding to the VOS into the user mode memory space.

The invention provides a method for constructing a VOS. When a computer is running in user mode, the VOS serves as a general library and all the applications do not directly invoke the OS interface but invoke the VOS instead, which does not need to run in kernel mode and has a wide range of applications. The VOS modifies the interface of the OS invoked by the application program, which does not damage the whole system due to VOS program errors. Even if there are serious bugs in VOS, only a local part will be affected but the entire operating system will not be affected, which enhances stability and security. Furthermore, the present invention is flexible to construct different VOSs for applications in different virtual environments according to requirements.

### BRIEF DESCRIPTION OF THE DRAWINGS

FIG. 1 is an implementation schematic view illustrating the method for constructing a VOS in accordance with the present invention.

FIG. 2 is a flowchart illustrating the method for constructing a VOS in accordance with the present invention.

### DETAILED DESCRIPTION OF THE PREFERRED EMBODIMENTS

The present invention will be described in more detail with reference to the drawings and embodiments.

The realization of a VOS has brought great convenience to people's works and lives. The VOS can simulate a user's habitual operating interface so that the user can use the many PCs configured in their own ways and user interface; The VOS can carry software and when the host OS does not install the software, the user can run the VOS-carried software to do the corresponding editing; The VOS can be stored in removable storage devices or servers so that users do not need to carry a heavy laptop computer to have the familiar operating environment in different PCs. The VOS is not a real OS but a special program responsible for detouring the acting of the application program and change the acting of the application program according requirements. The VOS plays an intermediary role between application programs and the host OS.

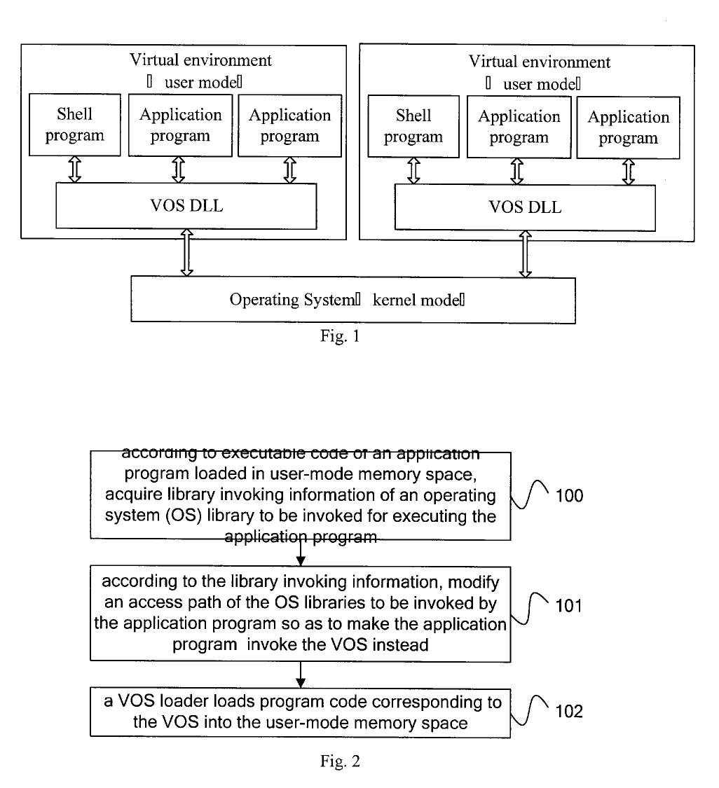

As shown in FIG. 1, it is an implementation schematic view illustrating the method for constructing a VOS in accordance with the present invention. In an OS, programs are running in user mode or kernel mode. In kernel mode, the program can do all the operations, including the installation of software. In user mode, there are more restrictions. For security considerations, under normal circumstances, public computers run in user mode. Correspondingly the memory space is divided into two parts, which are user mode memory space and kernel mode memory space. The application programs are written in the user-mode memory space and the OS programs are written in the kernel-mode memory space. The central idea of the present invention is to change the method in the prior art that a VOS is written into kernel-mode memory space to amend the application programs through the modification of the OS. The invention writes the dynamic link library (DLL) of VOS into user-mode memory space, intercepts the invoking of application programs to the OS, turns to implement the VOS, and realizes the modification to the application programs.

As shown in FIG. 2, it is a flowchart illustrating the method for constructing a VOS in accordance with the present invention. The method comprises following steps:

Step 100. according to executable code of an application program loaded in user-mode memory space, acquiring library invoking information of an operating system (OS) library to be invoked for executing the application program;

A virtual environment server is created responsible for the management of all the virtual environments. To create a virtual environment, a desktop and a shell should be created in order. The Shell program is to provide a user interface. When creating the shell, a VOS loader injects the VOS programs into the shell for making the shell invoke the VOS. Any one of the application programs opened from the shell in the follow-up steps will be configured in accordance with the same modification manner. The VOS replace the invocation of OS interface by the invocation of VOS for changing the performance of the application. As the shell is also an application program, the embodiment takes the implementation of general application as an example to describe the creation process of the VOS in user mode.

When executing an application program in the virtual environment, the virtual environment server can allocate memory space for the application program in user-mode memory space in accordance with the instruction message for executing the application program, and load the executable code of the application program into the allocated user mode memory space. Specifically, after the virtual environment server receives an operation instruction for executing an application program in the virtual environment, a memory space will be allocated in user memory space for the application program for storing the executable code for executing the application program. The memory space allocated by the virtual environment server is exclusive for the application program. After allocating the memory space, the virtual environment server will execute the executable code used for executing the application program, that is, the application program is loaded into the memory space. Furthermore, the executable code of the application program involves OS library to be invoked in the process of execution, such as a DLL file related to the OS and so on. Therefore, library invoking information of the OS to be invoked for executing the application program can be acquired through the executable code loaded into the memory space. The library invoking information is the information of which DDL files of the OS to be invoked in order to execute the application program.

Step 101. according to the library invoking information, modifying an access path of the OS library to be invoked by the application program so as to make the application program invoke the VOS;

After acquiring the library invoking information of the OS to be invoked to execute the application program, the OS library, i.e. the DLL file, to be invoked by the application program is acquired according to the library invoking information in order to make the application program not invoke the OS library but invoke the VOS instead. An access path of the OS library to be invoked by the application program is modified, that is, using a jump program to replace the executable program at the access entry of OS library. The application program turns to invoke the VOS in accordance with the jump program. Specifically, at the interface where the application program invokes the DLL file, a number of lines of code in front of the DLL file are copied to be taken out and saved, and are replaced by a section of jump program. The destination address of the jump program is the address in which the VOS is located so that when the application program is executed; all the invoking on the OS libraries is turned to invoke the VOS. The step of using the jump program to make the application program invoke the VOS specifically can be completed by a hook technique.

Step 102. a VOS loader loading program code corresponding to the VOS into the user-mode memory space

Because a jump program has been used to replace the application program for invoking a number of lines of code in front of the interface of the OS before, when the virtual environment server loads the executable code of the application program into the user-mode memory space, it will also load the program code corresponding to VOS to be invoked for executing the application program into the user-mode memory space. The loading can be completed by a module with the function such as a VOS loader in the virtual environment server. Because the program code corresponding to the VOS may also be stored in a DLL file, the VOS loader may perform an invoking link between the DLL file including the program code corresponding to the VOS and the executable code of the application program. By this way, the program code corresponding to the VOS are loaded into the user-mode memory space. The VOS exists in the form of DLLs so as to save physical memory space.

In the above embodiments, after using the jump program to replace the executable program at the access entry of the OS library, the executable program is stored for follow-up execution of invoking the OS library. When the executable program turns to invoke the VOS due to the jump program, if the OS library is further to be invoked based on practical needs, the executable program at the access entry of the OS library replaced by the jump program may be firstly executed, and returns back to invoke the OS library so as to achieve the aim that the application program invokes the OS. In the above operations of using the jump program to replace the executable program at the access entry of the OS library and storing the executable program at the access entry of the OS library replaced by the jump program, the modified part belongs to a user mode layer of the OS, and the operations are all performed in user mode memory space, which will not influence the host OS.

The invention provides a method for constructing a VOS. When a computer runs in user mode, the VOS serves as a general program library and all the applications do not directly invoke the OS interface but invoke the VOS instead, which does not need a kernel mode and has a wide range of applications. The VOS modifies the interface of the OS invoked by the application program, which does not affect the system due to VOS program errors. Even if there are program errors, only a local part will be affected but the entire system will not be affected, which enhances stability and security. Furthermore, the present invention is flexible to construct different VOSs for applications in different virtual environments according to requirements.

Finally, it should be understood that the above embodiments are only used to explain, but not to limit the technical solution of the present invention. In despite of the detailed description of the present invention with referring to above preferred embodiments, it should be understood that various modifications, changes or equivalent replacements can be made by those skilled in the art without departing from the spirit and scope of the present invention and covered in the claims of the present invention.

What is claimed is:

1. A method for constructing a virtual operating system (VOS), comprising:
according to executable code of an application program loaded in user-mode memory space, acquiring library invoking information of an operating system (OS) library to be invoked for executing the application program;
according to the library invoking information, modifying an access path of the OS library to be invoked by the application program so as to make the application program invoke the VOS; and
a VOS loader loading program code corresponding to the VOS into the user-mode memory space.

2. The method according to claim 1, wherein the step of, according to the library invoking information, modifying an access path of OS library to be invoked by the application program so as to make the application program invoke the VOS comprises:
according to the library invoking information, acquiring the OS library to be invoked by the application program; and
using a jump program to replace an executable program at an access entry of the OS library and the application program turning to invoke the VOS according to the jump program.

3. The method according to claim 2, during using the jump program to replace the executable program at the access entry of the OS library, further comprising:
storing the executable program at the access entry of the OS library replaced by the jump program.

4. The method according to claim 3, after the application program turns to invoke the VOS according to the jump program, further comprising:
executing the executable program at the access entry of the OS library replaced by the jump program and returning back to invoke the OS library.

5. The method according to claim 1, wherein the step of the VOS loader loading program code corresponding to the VOS into the user-mode memory space comprises:
the VOS loader performing an invoking link between a dynamic link library (DLL) file comprising program code corresponding to the VOS and the executable code of the application program.

6. The method according to claim 1, before acquiring library invoking information of the OS library to be invoked for executing the application program according to executable code of the application program loaded in user-mode memory space, further comprising:
according to an instruction message for executing the application program, allocating memory space for the application program in user-mode memory space; and
loading executable code of the application program into the allocated user-mode memory space.

7. The method according to claim 2, before acquiring library invoking information of the OS library to be invoked for executing the application program according to executable code of the application program loaded in user-mode memory space, further comprising:
according to an instruction message for executing the application program, allocating memory space for the application program in user-mode memory space; and
loading executable code of the application program into the allocated user-mode memory space.

8. The method according to claim 3, before acquiring library invoking information of the OS library to be invoked for executing the application program according to executable code of the application program loaded in user-mode memory space, further comprising:
according to an instruction message for executing the application program, allocating memory space for the application program in user-mode memory space; and
loading executable code of the application program into the allocated user-mode memory space.

9. The method according to claim 4, before acquiring library invoking information of the OS library to be invoked for executing the application program according to executable code of the application program loaded in user-mode memory space, further comprising:
according to an instruction message for executing the application program, allocating memory space for the application program in user-mode memory space; and
loading executable code of the application program into the allocated user-mode memory space.

10. The method according to claim 5, before acquiring library invoking information of the OS library to be invoked for executing the application program according to executable code of the application program loaded in user-mode memory space, further comprising:
according to an instruction message for executing the application program, allocating memory space for the application program in user-mode memory space; and
loading executable code of the application program into the allocated user-mode memory space.
